(19) United States
(12) Patent Application Publication
(10) Pub. No.: US 2013/0344338 A1
(43) Pub. Date: Dec. 26, 2013

(54) PROCESS FOR THE SURFACE TREATMENT OF COLLOIDAL SILICA AND PRODUCTS THEREOF

(71) Applicants: Paul Gregory Bekiarian, Wilmington, DE (US); Changzai Chi, Hockessin, DE (US); Gordon Mark Cohen, Wynnewood, PA (US)

(72) Inventors: Paul Gregory Bekiarian, Wilmington, DE (US); Changzai Chi, Hockessin, DE (US); Gordon Mark Cohen, Wynnewood, PA (US)

(73) Assignee: E.I. Du Pont de Nemours and Company, Wilmington, DE (US)

(21) Appl. No.: 14/004,695

(22) PCT Filed: Jun. 30, 2011
(86) PCT No.: PCT/US11/42469

§ 371 Date: Sep. 12, 2013

Related U.S. Application Data
(60) Provisional application No. 61/471,824, filed on Apr. 5, 2011.

(51) Int. Cl. C09C 1/30

(52) U.S. Cl. CPC C09C 1/3063
USPC 428/402; 556/425

(57) ABSTRACT

This invention relates to processes in which certain aminosilanes are used to surface-modify colloidal silica nanoparticles, while reducing or virtually eliminating the propensity of the silica nanoparticles to gel, agglomerate, or aggregate. The surface-modified colloidal silica nanoparticles can be readily dispersed in polymers to provide nanocomposites with one or more enhanced, desirable properties.

This application claims priority to Provisional Application No. 61/471,824 filed Apr. 5, 2011 which is herein incorporated by reference.

### FIELD OF THE INVENTION

This invention relates to processes for surface-treating colloidal silica nanoparticles with aminosilanes and the aminosilane-modified silica nanoparticles produced.

### BACKGROUND

Conventional filled polymer systems often have improved modulus, stiffness, and hardness relative to unfilled polymer systems. Use of nanofillers in polymers can improve the creep-resistance, wear-resistance, and modulus of the nanocomposite, without adversely affecting polymer aesthetics like clarity. Nanoparticles can also have a strong influence on the glass transition temperature (Tg) of polymers.

Although the high surface area of nanoparticles creates a large interface with host polymers, this high surface area also makes nanoparticles more prone to forming larger particles through agglomeration (a potentially reversible self-association that is frequently difficult and/or costly to reverse) or aggregation (an irreversible self-association). Agglomerated and aggregated nanoparticles frequently do not offer the level of benefits afforded by well-dispersed primary nanoparticles because they have less surface area in contact with the polymer matrix.

Colloidal silica is a potentially convenient source of nanoparticles (particles that are 100 nm in diameter or smaller) that might be blended with a polymer to improve various physical properties of the polymer. But colloidal silica can be difficult to disperse in solvents or polymers because the polar silanol groups on the surface of the nanoparticles can cause them to agglomerate. Even worse, the silanols can react chemically with each other (“condense”) and form irreversible linkages that cause the particles to irreversibly aggregate.

Attempts to overcome this tendency to agglomerate have included grafting polystyrene “brushes” onto the silica nanoparticle surface, but these modified particles are useful only for blends of polymers of the same composition as the brushes, namely polystyrene. In addition, this approach uses an expensive multistep, reversible addition-fragmentation chain transfer polymerization process, with smelly sulfur reagents, to modify the surface.

Silanes can also be used to modify silica surfaces like glass, glass fibers, and fumed silica (aggregates of silica nanoparticles), but is rarely used with primary, unaggregated silica particles. Phenylsilane modification improves the compatibility and dispersibility of silica nanoparticles in non-polar aromatic polymers such as polystyrene. Similarly, perfluoroalkylethylsilanes can be used for fluoropolymers.

In colloidal silica (unaggregated silica nanoparticles suspended in a liquid medium), surface modification is not as facile as it is with glass or aggregated particles. It can adversely affect the stability of the nanoparticles and cause them to agglomerate or irreversibly aggregate, which leads to particle clusters that are not nanoparticles. This agglomeration or aggregation can also make the particles settle out or form a gel. These suspended particle clusters, settled particles, or gels cannot usually be well-dispersed in polymers.

There is a further need to modify the surface of colloidal particles with specific functional groups that interact with the polymers into which they are to be blended to improve the ability to disperse these particles throughout the host polymer without substantial agglomeration or aggregation. Better dispersion leads to fewer large particle agglomerates and aggregates and, therefore, better clarity, an important property for many product applications. Better dispersion also increases the interfacial area between particles and polymer, enhancing properties like wear-resistance and modulus. Better attachment of the particles to the polymer can increase the polymer's modulus and wear-resistance. Better dispersion can increase the viscosity and reduce the mobility of the polymer and thereby improve its resistance to creep.

3-(Aminopropyl)triethoxysilane, 4-(aminobutyl)triethoxysilane, and other primary aminoalkylsilanes have been used to surface-modify silica particles where the particle size is 166 nm. 3-(Aminopropyl)triethoxysilane (“APTES”) has been used to surface-modify silica gel particles of 60-125 microns in diameter. When APTES was used to surface-modify colloidal polypyrrole-silica particles of 113 nm in diameter, an increase in particle diameter after amination was noted, indicating some degree of flocculation. It has also been found that aminosilane modification of 100 nm colloidal silica using APTES causes flocculation, but that diethoxymethyl(aminopropyl)silane and monoethoxydimethyl(aminopropyl)silane give stable dispersions with no increase in particle size. Trialkoxysilanes are preferred over dialkoxyalkylsilanes and alkoxydialkylsilanes for surface modification because they react more rapidly than silanes with only one or two alkoxy groups.

It has also been found that these most commonly used aminosilanes cannot be used to surface modify colloidal silica with nanoparticles because they cause the nanoparticles to gel, agglomerate, or aggregate.

Thus, there remains a need to find aminosilanes that surface-modify colloidal silica without causing the silica nanoparticles to gel, agglomerate, or aggregate. There also remains a need for surface-modified silica nanoparticles with surface amine functionality that do not readily agglomerate or aggregate and a process for preparing such surface-modified nanoparticles.

### SUMMARY

One aspect of the present invention is a process comprising forming a reaction mixture comprising a dispersion of colloidal silica nanoparticles and an aminosilane of Formula 1:

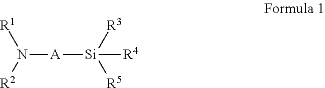

wherein
the colloidal silica nanoparticles have an average diameter of less than 75 nm,
R¹ and R² are independently selected from the group consisting of H, C₁-C₁₀ alkyl, C₃-C₁₀ alkenyl and C₆-C₁₀ aryl;
A is a linker group selected from the group consisting of C₁-C₂₀ alkylene, C₆-C₂₀ arylene, and C₇-C₂₀ arylalkylene;
R³ is a C₁-C₁₀ alkoxy group; and
R⁴ and R⁵ are independently selected from the group consisting of C₁-C₁₀ alkyl and C₁-C₁₀ alkoxy groups,
provided that if R¹ and R² are H, A is phenylene.

Another aspect of this invention is the aminosilane-modified silica nanoparticles produced by this process.

### DETAILED DESCRIPTION

Described herein are processes in which certain aromatic aminosilanes, aromatic aminoalkylsilanes, alkenyl aminoalkylsilanes, and secondary and tertiary aliphatic aminosilanes can be used to surface-modify colloidal silica nanoparticles, while reducing or virtually eliminating the propensity of the silica nanoparticles to gel, agglomerate, or aggregate. These silanes can also be used in conjunction with other conventional silane surface modifiers such as phenylsilanes and trimethylsilyl group capping agents such as 1,1,1,3,3,3-hexamethyldisilazane (HMDS). The surface-modified silica nanoparticles can be readily dispersed in polymers to provide nanocomposites with one or more enhanced, desirable properties.

Colloidal silica nanoparticle dispersions are commercially available as either an aqueous dispersion or as a dispersion in an organic solvent. The dispersions can also be prepared by methods known in the art. The colloidal silica nanoparticles typically have an average particle size of less than 75 nm, or less than 50 nm. Suitable dispersions comprise about 1 to about 70 wt %, or about 5 to about 50 wt %, or about 7 to about 30 wt % of colloidal silica nanoparticles, the balance being predominantly the aqueous or organic medium of the dispersion. Suitable organic solvents include alcohols (e.g., isopropanol, methanol), amides (e.g., dimethylacetamide, dimethylformamide) and ketones (e.g., 2-butanone).

Suitable aminosilanes include aminosilanes of Formula 1

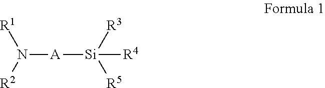

wherein
R¹ and R² are independently selected from the group consisting of H, C₁-C₁₀ alkyl, C₃-C₁₀ alkenyl, and C₆-C₁₀ aryl;
A is a linker group selected from the group consisting of C₁-C₂₀ alkylene, C₆ arylene, and C₇-C₂₀ arylalkylene; and
R³ is a C₁-C₁₀ alkoxy group;
R⁴ and R⁵ are independently selected from the group consisting of C₁-C₁₀ alkyl and C₁-C₁₀ alkoxy groups,
provided that if R¹ and R² are H, A is phenylene.

Specific examples of suitable aminosilanes include p-aminophenyltrimethoxysilane, p-aminophenyltrimethoxysilane, N-phenylaminopropyltrimethoxysilane N-phenylaminopropyltriethoxysilane, n-butylaminopropyltrimethoxysilane, n-butylaminopropyltriethoxysilane, 3-(N-allylamino)propyltrimethoxysilane, (N,N-diethyl-3-aminopropyl)trimethoxysilane, and (N,N-diethyl-3-aminopropyl)triethoxysilane.

Aminosilanes of Formula 1 can be obtained from commercial sources or prepared by methods know in the art.

To prepare the surface-modified silica nanoparticles, aminosilane is typically added to the colloidal silica nanoparticle dispersion in a molar amount equal to about 30% to about 50% of the accessible silanol groups estimated to be on the surface of the nanoparticles. Thus, the aminosilane is typically added at a level of about 1.5 to about 4 molecules per square nanometer of silica surface area. The silica surface area can be determined by the BET (Brunauer, Emmet, Teller) method, for example using an adaptation of ASTM D1993-03 (2008) “Standard Test Method for Precipitated Silica-Surface Area by Multipoint BET Nitrogen Adsorption.”

In some embodiments, the reaction mixture further comprises one or more other aminosilanes of Formula 1. In some embodiments, the reaction mixture comprises one or more other silanes. Suitable other silanes should not cause the colloidal silica nanoparticles to gel, agglomerate, or aggregate. Suitable other silanes include phenyltrimethoxysilane and octyltrimethoxysilane.

In some embodiments, the process further comprises adding a trimethylsilyl group capping agent such as 1,1,1,3,3,3-hexamethyldisilazane (HMDS) to the reaction mixture. Such capping agents react with accessible silanol groups on the silica surface that have not been modified by the aminosilanes and the optional other silanes. The capping agents are therefore most conveniently added after the reaction with the aminosilanes has been carried out. The capping agent can be added at a level that is equivalent to the number of silanol groups that have not been modified by the silanes. Excess capping agent can also be used if it is volatile, and excess unreacted capping agent can be driven out of the reaction mixture by evaporation or distillation. Alternatively, excess capping agent can be left in the reaction mixture containing the aminosilane-modified silica nanoparticles and removed in later processing steps, e.g., during the preparation of nanocomposites, when the silica nanoparticles are combined with a polymer.

Use of capping agents allows one to fine-tune the amount of amine functionality, while still covering the surface with silanes to block accessible Si—OH groups that can cause particle aggregation. For example, Me₃Si capping (via HMDS) removes essentially all accessible Si—OH sites that might cause particle aggregation. This can make it possible to dry the particles, and then redisperse them in a solvent to their original, small nanoparticle size, with few agglomerates or aggregates.

HMDS and silanes such as trimethylmethoxysilane, phenyldimethylmethoxysilane and octyldimethylmethoxysilane can be used as capping agents and can be obtained from commercial sources.

In some embodiments, the process further comprises heating the reaction mixture. For example, the aminosilane can be added to the colloidal silica nanoparticles with agitation, followed by heating the mixture to the desired temperature, e.g., the boiling point of the solvent. The heating can be continued until a substantial portion of the aminosilane has been reacted with the silica. The heating can be continuous or discontinuous. Typical total heating times can be from about 0.1 hour to 100 hours, or about 1 to 48 hours, or about 2 to 24 hours.

In some embodiments, the reaction mixture further comprises a catalyst or a reaction accelerator, allowing the reaction to be run at a lower temperature and/or for a shorter time.

In some embodiments, the process further comprises an ultrasonic treatment step in which ultrasonic energy is delivered by an ultrasonic bath, probe, or other suitable source to break up any loose dusters or agglomerates of nanoparticles that may have formed during the surface modification process.

In some embodiments, the process further comprises isolating the aminosilane-modified silica nanoparticles by evaporating water or the organic solvent at room temperature or by using gentle heating. More severe heating may cause the nanoparticles to agglomerate or aggregate. In some embodiments, removal of water or organic solvent is carried out at reduced pressure.

In some embodiments, the process further comprises washing the aminosilane-modified silica nanoparticles with a solvent selected from the group consisting of alcohols, aromatic solvents, ethers, and combinations thereof.

Another aspect of this invention is a nanocomposite comprising a polymer and aminosilane-modified silica nanoparticles, wherein the aminosilane is a compound of Formula 1, as defined above. These nanocomposites can have enhanced properties when compared with the host polymers. Enhanced properties can include improved wear-resistance, creep, and modulus.

Suitable polymers include ethylene copolymers that contain carboxylic groups, polymethyl methacrylate-methacrylic copolymers, and polybutadiene-methacrylic acid copolymers, and also ionomers derived from these copolymers by fully or partly neutralizing the carboxylic groups with basic metal salts. Suitable polymers include Nucrel® ethylene copolymers, Surlyn® ionomers, and SentryGlas® glass interlayers, which are available from E.I. du Pont de Nemours and Company, Wilmington, Del. Surlyn® can be used as a photovoltaic device encapsulant and or in cosmetic bottle caps. The aminosilane-modified colloidal silica nanoparticles of this invention can impart additional creep-resistance to Surlyn® in these applications. The aminosilane-modified colloidal silica nanoparticles can also improve the wear-resistance of Surlyn®, making it even more attractive in floor tile coating and floor-polishing compositions.

The amine-carboxylic acid interaction between aminosilane-modified colloidal silica nanoparticle and the polymer can facilitate the dispersion of the particles into the polymer and increase the enhancement of certain properties such as wear-resistance and creep-resistance.

In some embodiments, the aminosilane-modified silica nanoparticles produced by the processes of this invention can be used without first isolating them from the reaction mixture. For example, the reaction mixture containing the aminosilane-modified silica nanoparticles can be used in a solution-blending process to form polymer nanocomposites.

In some embodiments, the aminosilane-modified silica nanoparticles can be isolated from the solvent, dried, and added to the polymer directly by a melt-blending process. In such a process, the particles are added to the molten polymer in a mixer such as an extruder, a Brabender PlastiCorder®, an Atlantic mixer, a Sigma mixer, a Banbury mixer, or 2-roll mill.

Alternatively, the isolated aminosilane-modified silica nanoparticles can be mixed with a polymer in a compatible solvent. In this process, the aminosilane-modified colloidal silica and the polymer are in the same solvent, or are in solvents that are miscible with each other. This process can afford nanocomposites in which the silica particles are well-dispersed within the host polymer after removal of the solvent, without a substantial number of agglomerates or aggregates of silica particles in the host polymer.

### EXAMPLES

### General

Colloidal silica was obtained from either Gelest (Morrisville, Pa.; 30-31.5 wt % SiO₂ (16-20 nm) in isopropyl alcohol, #SIS6963.0) or Nissan Chemical (Organosol® IPA-ST-MS, 30 wt % SiO₂ (17-23 nm diameter) in isopropyl alcohol, IPA).

(3-Aminopropyl)triethoxysilane (‘APTES’, FW=221.37) and 1,1,1,3,3,3-hexamethyl disilazane (99.9%, #379212, bp=125° C., spgr=0.774, FW=161.4) were obtained from Aldrich (St. Louis, Mo.).

The following aminosilanes were supplied by Gelest (Morrisville, Pa.):

bis(2-hydroxyethyl)-3-aminopropyltriethoxysilane, 62% in ethanol, (MW=309.5, #SIB1140.0);

### 3-(N-allylamino)propyltrimethoxysilane (W=219.35, #SIA0400.0)

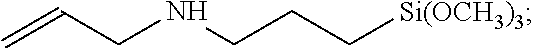

p-aminophenyltrimethoxysilane (MW=213.3, #SIA0599.1, 90%)

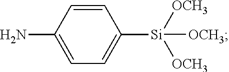 [SMILES: CO[Si](OC)(OC)c1ccc(N)cc1]

n-butylaminopropyltrimethoxysilane (MW=235.4, #SIB1932.2, d=0.947)

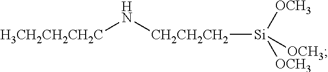

N-phenylaminopropyltriethoxysilane (MW=255.38, #SIP6724.0, 95% d=1.07);

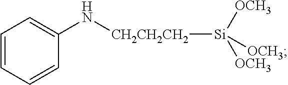

and (N,N-diethyl-3-aminopropyl)trimethoxysilane (MW 235.4, #SID3396.0, d=0.934).

Dynamic light scattering measurements were carried out with either a Zetasizer Nano-S (Malvern Instruments) or a Brookhaven Instruments BI9000. Commercially available software, 90Plus/BI-MAS, was used to calculate the effective diameter, polydispersity, and diffusion coefficient parameters of the treated and untreated colloidal silica samples from the dynamic light scattering data.

### Comparative Examples A-D

### Treatment of Colloidal Silica with (3-aminopropyl)triethoxysilane

These Comparative Examples demonstrate that treatment of colloidal silica with a primary aminoalkylsilane results in gel formation.

Colloidal SiO₂ from Gelest was added to each of four 100 ml, 3-neck round-bottomed flasks, with optional isopropyl alcohol (IRA) and an optional catalytic trace of water as shown in Table 1. A stirring bar was added and a water-cooled condenser attached. Rapid stirring was begun at room temperature. The aminosilane was added via needle and syringe at room temperature to the flasks. The contents remained liquid but became cloudy. In Comparative Examples A, B, and C, the flask contents turned into a monolithic gel in about 5 min at room temperature. Comparative Example A was heated to reflux for about 30 minutes and did not liquefy. Comparative Example D was heated to reflux for about 30 min, at which time pieces of gel formed. The added isopropyl alcohol in Comparative Example D delayed the gelation, but did not stop it. All samples remained gelled after standing for three days at room temperature.

The gel formation is attributed to agglomeration and network formation. It is believed that the aminosilane agglomerates the SiO₂ particles by bridging them by reaction of both its silane and sterically unhindered primary amine ends with the silica surface.

TABLE 1
Treatment of colloidal silica with (3-aminopropyl)triethoxysilane

| | Comparative Examples | | | |
|---|---|---|---|---|
| | A | B | C | D |
| Colloidal silica, 30 wt % in IPA, g | 50.0 | 50.0 | 50.0 | 25.0 |
| (Gelest) | | | | |
| Isopropyl alcohol, 99.5%, g | — | — | — | 125.0 |
| Deionized water, g | 0.5 | — | 0.5 | 0.05 |
| APTES, (99%, d 0.949), g | 1.7 | 1.7 | 2.5 | 0.9 |

### Comparative Examples E-F

### Treatment of Colloidal Silica with (3-aminopropyl)triethoxysilane

These Comparative Examples demonstrate that treatment of a different source of colloidal silica with a primary aminoalkylsilane also results in gel formation.

The method of Comparative Example D was repeated, except that colloidal SiO₂ from Nissan Chemical was used in place of the Gelest material. The reagents are shown in Table 2. The mixtures became cloudy when the aminosilane was added to the flask at room temperature and gelled within 10 min after beginning to heat them to reflux.

TABLE 2
Treatment of colloidal silica with (3-aminopropyl)triethoxysilane

Comparative
Examples

| | E | F |
|---|---|---|
| Colloidal silica, 30 wt % in IPA, g (Nissan | 50.0 | 50.0 |
| Chemical | | |
| APTES, (99%, d 0.949), g | 1.7 | 2.5 |

### Comparative Example G

### Treatment of Colloidal Silica with bis(2-hydroxyethyl)-3-aminopropyltriethoxysilane

This example demonstrates that aminoalkyl silanes cause undesirable agglomeration if they contain additional reactive groups like primary hydroxyl.

Colloidal SiO₂ from Nissan Chemical was added to a 250 ml, 3-neck round-bottomed flask, and diluted with isopropyl alcohol as shown in Table 3. A stirring bar was added and a water-cooled condenser attached with a drying tube atop it. Rapid stirring was begun at room temperature. The aminosilane was added via needle and syringe at room temperature to the flask. The mixture was heated and it gradually became milky, without a viscosity increase. The mixture was held at reflux for 6.5 hr, then cooled to room temperature with stirring. The mixture's appearance remained milky, an indication that the particles had agglomerated to a larger size that scattered light.

Well-stirred 4.5-g portions of the colloidal dispersion were diluted with 25.5-g portions of 2-butanone and tetrahydrofuran. In both solvents, the dispersion was cloudy and some settling occurred within 2 days. The lack of transparency and the settling are an indication that there was agglomeration to particle clusters large enough to scatter light and settle out of suspension.

TABLE 3
Treatment of colloidal silica with bis(2-hydroxyethyl)-3-
aminopropyltriethoxysilane
Comparative Example G

| | |
|---|---|
| Colloidal silica, 30 wt % in IPA, g (Nissan Chemical)) | 25.0 |
| Isopropanol, g | 50.0 |
| Bis(2-hydroxyethyl)-3-aminopropyltriethoxysilane, 62% | 1.5 |
| in ethanol, g | |

### Example 1

### Treatment of Colloidal Silica with p-aminophenyltrimethoxysilane

This example shows that aminosilanes that contain the less basic aromatic amine groups do not cause agglomeration, which is believed to result because the aromatic amines are less reactive directly with the silica surface or less catalytically active.

Colloidal SiO₂ from Nissan Chemical was added to a 250 ml, 3-neck round-bottomed flask, and diluted with isopropyl alcohol as shown in Table 4. A stirring bar was added and a water-cooled condenser attached with a drying tube atop it. Rapid stirring was begun at room temperature. The aminosilane was added via needle and syringe at room temperature to the flask, making the mixture hazy in appearance. The mixture was heated and held at reflux for 6 hr, then cooled to room temperature. It remained hazy, without a viscosity increase, an indication that the particles had not agglomerated to a larger size that would have scattered more light.

Well-stirred 4.5-g portions of the colloidal dispersion were diluted with 25.5-g portions of 2-butanone and tetrahydrofuran. In both solvents, the dispersion was initially clear and remained so for more than 2 days. The transparency and absence of settling are an indication that the particle size remains small enough to avoid scattering light and to resist settling. It is also evidence that the surface was modified, because the unmodified SiO₂ cannot remain suspended and unagglomerated in these solvents.

TABLE 4
Treatment of colloidal silica with p-aminophenyltrimethoxysilane
Example 1

| | |
|---|---|
| Colloidal silica, 30 wt % in IPA, g (Nissan Chemical) | 25.0 |
| Isopropanol (EM, 99.5%), g | 50.0 |
| p-Aminophenyltrimethoxysilane, g | 0.64 |

By dynamic light scattering in a Zetasizer Nano-S, the volume-average d50 particle diameter was 30 nm and the d90 was 56 nm, only slightly larger than the starting material, with no evidence of agglomeration in the particle size distribution plot. The d50 and d90 of the untreated colloidal silica (Organosor IPA-ST-MS) were 23 and 43 nm, respectively.

### Examples 2-4

### Treatment of Colloidal Silica with p-aminophenyltrimethoxysilane

These examples demonstrate that colloidal SiO₂ can be surface-modified by an aromatic aminosilane without substantial agglomeration.

Colloidal SiO₂ from Nissan Chemical was added to three 250 ml, 3-neck round-bottomed flasks, and diluted with isopropyl alcohol as shown in Table 5. To each flask, a stirring bar was added and a water-cooled condenser attached with a drying tube atop it. Rapid stirring was begun at room temperature. The aminosilanes were added via needle and syringe at room temperature to the flask, making the mixture hazy in appearance. The mixtures were heated and remained hazy, without a viscosity increase. Over a 3-day period, mixtures 2 and 3 were held at reflux for 20 hr, then cooled to room temperature. After 16 hr of reflux time, mixture 4 was cooled to room temperature, and then 1,1,1,3,3,3-hexamethyldisilazane was added. This mixture was held at room temperature for 4 hr, heated to reflux for 4 hr, and then cooled to room temperature. None of the mixtures was gelled at room temperature.

TABLE 5
Treatment of colloidal silica with p-aminophenyltrimethoxysilane

| | Examples | | |
|---|---|---|---|
| | 2 | 3 | 4 |
| Colloidal silica, 30 wt % in IPA, g (Nissan | 25.0 | 25.0 | 25.0 |
| Chemical) | | | |
| Isopropanol g | 50.0 | 50.0 | 50.0 |
| Deionized water, g | 0.3 | — | — |
| p-Aminophenyltrimethoxysilane, g | 0.64 | 0.64 | 0.64 |
| Hexamethyldisilazane, g | — | — | 2.6 |

The colloidal mixtures were designated 2A, 3A, and 4A and submitted for particle size analysis. A 50.0-g portion of each was allowed to evaporate slowly in an evaporating dish overnight, yielding 6.1 to 6.6 g of solid, designated 2B, 3B, and 4B. Half of each solid was ground to a powdery state and cleaned up on a filter by washing on a vacuum filter successively with two portions each of isopropanol, toluene, and tetrahydrofuran, in that order. During each wash, the solid was slurried for a short time with the solvent before pulling vacuum. The solids were dried and designated respectively 2C, 3C, and 4C. Both sets of solids, before and after washing, were submitted for elemental analysis, electron spectroscopy for chemical analysis (ESCA), and diffuse reflectance infrared Fourier transform (DRIFT).

As shown in Table 6, by dynamic light scattering in a Zetasizer Nano-S, the volume-average d50 and d90 particle diameters are substantially the same as the untreated colloidal silica, whether or not a small amount of water promoter is added. The particle diameters are also unaffected by the addition of a second silane that does not also modify the silica surface with amine groups. For example, 1,1,1,3,3,3-hexamethyldisilazane puts Me₃Si-groups on the surface of the silica.

The four analytical methods indicate that aminosilane is added to the surface of the SiO₂ particles, and that a significant portion of the aminosilane is retained even after multiple solvent washing cycles. As shown by the % N from the microanalysis of the treated particles, amine is present on the dried SiO₂ particles. As shown by the changes in % C, % H, and % N in the microanalysis, approximately 55-86% of the aminosilane on the particle surface is retained on the particles after washing. ESCA analysis of the total surface N before and after washing shows that about 60-75% of the aminosilane on the particle surface is retained after washing of the particles. A comparison of the peak heights for the phenyl peak at 1602 cm⁻¹ by DRIFT analysis before and after washing, shows that 23-38% of the aminosilane on the particle surface is retained after washing of the particles.

TABLE 6
Particle size and compositional analysis

| | Examples | | | |
|---|---|---|---|---|
| | Untreated | | | |
| | colloidal | | | |
| | silica | 2 | 3 | 4 |
| Particle size, d50, at 0.1 wt % | 23 | 12 | 14 | 17 |
| SiO_{2/}IPA, nm | | | | |
| Particle size, d90, at 0.1 wt % | 43 | 25 | 44 | 39 |
| SiO_{2/}IPA, nm | | | | |
| Particle size, d50, at 0.01 wt | 24 | 34 | 31 | 27 |
| % SiO_{2/}IPA, nm | | | | |
| Particle size, d90, at 0.01 wt | 42 | 78 | 56 | 49 |
| % SiO_{2/}IPA, nm | | | | |
| % C, H, N (microanalysis) | | 2.6/0.50/0.10 | 3.3/0.64/0.22 | 3.7/0.72/0.18 |
| before washing, Samples | | | | |
| 2B-4B | | | | |
| Expected % N if all of amino | | 0.52 | 0.52 | 0.52 |
| silane is added | | | | |
| % C, H, N (microanalysis) | | 1.9/0.46/0.08 | 1.9/0.46/0.09 | 2.8/0.60/0.12 |
| after washing, Samples | | | | |
| 2C-4C | | | | |
| % retention of C/H/N after | | 72/93/75 | 56/71/42 | 75/83/62 |
| washing | | | | |
| ESCA, atom % N before | | 0.5 | 0.6 | 0.6 |
| washing, Samples 2B-4B | | | | |
| ESCA, atom % N after | | 0.4 | 0.4 | 0.4 |
| washing, Samples 2C-4C | | | | |
| ESCA % retention of % N | | 73 | 60 | 66 |
| after washing | | | | |
| DRIFT, % retention of phenyl | | 23 | 38 | 38 |
| peak at 1602 cm⁻¹ after | | | | |
| washing | | | | |

### Examples 5-7

### Treatment of Colloidal Silica with Aminosilanes and HMDS

These examples demonstrate that colloidal SiO₂ can be surface-modified by aromatic and secondary or tertiary aliphatic aminosilanes that do not bear additional hydroxyl functionality without substantial agglomeration.

Colloidal SiO₂ from Nissan Chemical was added to three 250 ml, 3-neck round-bottomed flasks, and diluted with isopropyl alcohol as shown in Table 7. To each flask, a stirring bar was added and a water-cooled condenser attached with a drying tube atop it. Rapid stirring was begun at room temperature. The aminosilanes were added via needle and syringe at room temperature to the flasks, making the mixtures hazy in appearance. The mixtures were heated and remained hazy, without a viscosity increase. Over a 3-day period, the mixtures were held at reflux for 23 hr then cooled to room temperature. 1,1,1,3,3,3-Hexamethyldisilazane was added, and the mixtures held at room temperature for 4 hr. The mixtures were heated to reflux for 4 hr, and then cooled to room temperature None of the mixtures was gelled at room temperature.

TABLE 7
Treatment of colloidal silica with other aminosilanes and HMDS

| | Examples | | |
|---|---|---|---|
| | 5 | 6 | 7 |
| Colloidal silica, 30 wt % in IPA, g (Nissan | 25.0 | 25.0 | 25.0 |
| Chemical) | | | |
| Isopropanol, g | 50.0 | 50.0 | 50.0 |
| n-Butylaminopropyltrimethoxysilane, g | 0.71 | — | — |
| N-Phenylaminopropyltrimethoxysilane, g | — | 0.77 | — |
| (N,N-Diethyl-3-aminopropyl)trimethoxysilane, g | — | — | 0.71 |
| After 23 hr at reflux, added: | 2.6 | 2.6 | 2.6 |
| Hexamethyldisilazane, g | | | |

The colloidal mixtures were designated 5A, 6A, and 7A. These samples were diluted with isopropanol to 0.24 wt % solids and then sonicated with a bath sonicator. They were submitted for particle size analysis, along with an untreated colloidal silica sample. A 50.0-g portion of each was allowed to evaporate slowly in an evaporating dish overnight, yielding 5.1 to 5.7 g of solid, designated 5B, 6B, and 7B. A 1-g portion of each solid was ground to a powdery state and cleaned up on a filter by washing on a vacuum filter successively with two portions each of isopropanol, toluene, and tetrahydrofuran, in that order. During each wash, the solid was slurried for a short time with the solvent before pulling vacuum. The solids were dried and designated respectively 5C, 6C, and 7C. Both sets of solids, before and after the washing, were air-dried, then dried in a vacuum oven overnight at 50° C. with a slight nitrogen bleed. The solid samples were then submitted for elemental analysis and ESCA.

As shown in Table 8, by dynamic light scattering in a Brookhaven Instruments BI9000, the effective diameters (which are most sensitive to the largest particles in the colloids) and polydispersities (breadth of the particle size distributions) are substantially the same as, or less than, the untreated colloidal silica, indicating that agglomeration has not occurred to a significant extent.

Independent analytical methods indicate that the aminosilanes are added to the surface of the SiO₂ particles and that a significant portion of the aminosilanes is retained, even after several solvent washing cycles. As shown by the % N from the microanalysis of the treated particles, amine is present on the dried SiO₂ particles. As shown by the changes in % C, % H, and % N in the microanalyses of samples (5B, 5C) and (7B, 7C), most of the aliphatic aminosilanes are retained after washing the particles. As shown by the changes in % C, % H, and % N in the microanalysis of samples (6B, 6C), about half of the aromatic aminosilane is retained on the particle surface after washing the particles. ESCA confirms these results.

TABLE 8
Particle size, polydispersity and compositional analysis

| | Examples | | | |
|---|---|---|---|---|
| | Untreated | | | |
| | colloidal | | | |
| | silica | 5 | 6 | 7 |
| Particle size, effective | 36 | 29 | 25 | 40 |
| diameter, nm | | | | |
| Polydispersity | 0.30 | 0.12 | 0.28 | 0.15 |
| % C, H, N (microanalysis) | | 4.3/0.93/0.48 | 7.3/1.26/0.50 | 4.5/0.98/0.50 |
| before washing, 5B-7B | | | | |
| Expected % N if all of amino | | 0.51 | 0.51 | 0.51 |
| silane is added | | | | |
| % C, H, N (microanalysis) | | 4.1/0.90/0.44 | 3.4/0.68/0.22 | 4.1/0.87/0.44 |
| after washing, 5C-7C | | | | |
| % retention of C/H/N after | | 97/96/92 | 47/53/44 | 91/89/88 |
| washing | | | | |
| ESCA, atom % N before | | 1.5 | 1.2 | 1.5 |
| washing, 5B-7B | | | | |
| ESCA, atom % N after | | 1.4 | 0.8 | 1.2 |
| washing, 5C-7C | | | | |
| ESCA % retention of % N | | 95 | 65 | 81 |
| after washing | | | | |

“Polydispersity” is the relative standard deviation of the particle size.

### Examples 8-9

### Treatment of Colloidal Silica with Aminosilanes and HMDS

These examples also demonstrate that colloidal SiO₂ can be surface-modified by aromatic and secondary aliphatic aminosilanes without substantial agglomeration.

Colloidal SiO₂ from Nissan Chemical was added to two 1000-ml, 3-neck round-bottomed flasks, and diluted with isopropyl alcohol as shown in Table 9. To each, a stirring bar was added and a water-cooled condenser attached with a drying tube atop it. Rapid stirring was begun at room temperature. The aminosilanes were added via needle and syringe at room temperature to the flasks, making the mixtures hazy in appearance. The mixtures were heated and remained hazy, without a viscosity increase. Over a 3-day period, the mixtures were held at reflux for 24 hr, then cooled to room temperature. 1,1,1,3,3,3-Hexamethyldisilazane was added, and the mixtures held at room temperature for 4 hr. The mixtures were heated to reflux for 4 hr, and then cooled to room temperature. None of the mixtures was gelled at room temperature,

TABLE 9
Treatment of colloidal silica with aminosilanes and HMDS

| | Examples | |
|---|---|---|
| | 8 | 9 |
| Colloidal silica, 30 wt % in IPA, g (Nissan Chemical), | 125.0 | 125.0 |
| g | | |
| Isopropanol, g | 250.0 | 250.0 |
| n-Butylaminopropyltrimethoxysilane, g | 3.55 | — |
| N-Phenylaminopropyltrimethoxysilane, g | — | 3.85 |
| Hexamethyldisilazane, g | 13.0 | 13.0 |

The colloidal mixtures were designated 8A and 9A. Samples were diluted with isopropanol to 0.24 wt % solids and then sonicated with a bath sonicator. The samples were submitted for particle size analysis, along with an untreated colloidal silica sample. A 20.0-g portion of each was allowed to evaporate slowly in an evaporating dish overnight, each yielding 2.4 g of solid, designated 8B and 9B. A 0.5-g portion of each solid was ground to a powdery state and cleaned up on a filter by washing on a vacuum filter successively with two portions each of isopropanol, toluene, and tetrahydrofuran, in that order. During each wash, the solid was slurried for a short time with the solvent before pulling vacuum. The solids were dried and designated respectively 80 and 90. Both sets of solids, before and after washing, were air-dried, then dried in a vacuum oven overnight at 50° C. with a slight nitrogen bleed, and then submitted for elemental analysis.

As shown in Table 10, by dynamic light scattering in a Brookhaven Instruments BI9000, the effective diameters (which are most sensitive to the largest particles in the colloids) and polydispersities (breadth of the particle size distributions) are substantially the same as, or less than, the untreated colloidal silica, indicating that agglomeration has not occurred to a significant extent.

The analytical methods indicate that aminosilane is added to the surface of the SiO₂ particles and that a significant portion of the aminosilane is retained even after several solvent washing cycles. As shown by the % N from the microanalysis of the treated particles, amine is present on the dried SiO₂ particles. As shown by the changes in % C, % H, and % N in the microanalyses of example 8, most of the aminosilane on the particle surface is retained after washing of the particles. As shown by the changes in % C, % H, and % N in the microanalyses of example 9, about half of the aminosilane on the particle surface is retained after washing of the particles.

TABLE 10
Particle size, polydispersity and compositional analysis

| | Examples | | |
|---|---|---|---|
| | Untreated | | |
| | colloidal | | |
| | silica | 8 | 9 |
| Particle size, effective diameter, | 36 | 31 | 25 |
| nm | | | |
| Polydispersity | 0.30 | 0.14 | 0.29 |
| % C, H, N (microanalysis) | | 4.3/0.96/0.50 | 7.1/1.25/0.48 |
| before washing, 8B, 9B | | | |
| Expected % N if all of amino | | 0.51 | 0.51 |
| silane is added | | | |
| % C, H, N (microanalysis) after | | 3.6/0.90/0.50 | 3.3/0.69/0.24 |
| washing, 8C, 9C | | | |
| % retention of C/H/N after | | 84/93/102 | 46/55/49 |
| washing | | | |

### Example 10

### Treatment of Colloidal Silica with n-butylaminopropyltrimethoxysilane

This example demonstrates that even in the absence of the secondary hexamethyldisilazane modifier, colloidal SiO₂ can be surface-modified by a secondary aliphatic aminosilane without substantial agglomeration.

Colloidal SO₂ from Nissan Chemical was added to a 1000 ml, 3-neck round-bottomed flask and diluted with isopropyl alcohol as shown in Table 11. A stirring bar was added and a water-cooled condenser attached with a drying tube atop it. Rapid stirring was begun at room temperature. The aminosilane was added via needle and syringe at room temperature to the flask, making the mixture hazy in appearance. The mixture was heated and remained hazy, without a viscosity increase. Over a 3-day period, the mixture was held at reflux for 24 hr, then cooled to room temperature. The mixture was not gelled at room temperature.

TABLE 11
Treatment of colloidal silica with
n-butylaminopropyltrimethoxysilane
Example 10

| | |
|---|---|
| Colloidal silica, 30 wt % in IPA, g (Nissan | 125.0 |
| Chemical), g | |
| Isopropanol, g | 250.0 |
| n-Butylaminopropyltrimethoxysilane, g | 3.55 |

The colloidal mixture was designated 10A. A sample, diluted with isopropanol to 0.24 wt % solids and then sonicated with a bath sonicator, was submitted for particle size analysis, along with an untreated colloidal silica sample. A 20.0-g portion of the mixture was allowed to evaporate slowly in an evaporating dish overnight, yielding 2.2 g of solid, designated 10B. A 0.5-g portion of the solid was ground to a powdery state and cleaned up on a filter by washing on a vacuum filter successively with two portions each of isopropanol, toluene, and tetrahydrofuran, in that order. During each wash, the solid was slurried for a short time with the solvent before pulling vacuum. The solid was dried and designated 10C. Both sets of solids, before and after the washing, were air-dried, then dried in vacuum oven overnight at 50° C. with a slight nitrogen bleed. The dried samples were submitted for elemental analysis.

As shown in Table 12, by dynamic light scattering in a Brookhaven Instruments BI9000, the effective diameter and polydispersity are substantially the same as, or less than, the untreated colloidal silica sample, indicating that agglomeration has not occurred to a significant extent.

These analytical methods indicate that n-butylaminopropyltrimethoxysilane is added to the surface of the SiO₂ particles and that a significant portion of the n-butylaminopropyltrimethoxysilane is retained even after multiple solvent washing cycles. As shown by the % N from the microanalysis of the treated particles, amine is present on the dried SiO₂ particles. As shown by the changes in % C, % H, and % N in the microanalysis, most of the n-butylaminopropyltrimethoxysilane on the particle surface is retained after washing the particles. Comparison with Examples 5 and 8 indicates that the absence of hexamethyldisilazane as a secondary surface-modifier in Example 10 is not detrimental.

TABLE 12
Particle size, polydispersity and compositional analysis

| | Examples | |
|---|---|---|
| | Untreated | |
| | colloidal | |
| | silica | 10 |
| Particle size, effective diameter, nm, | 36 | 33 |
| (90° scattering angle) | | |
| Polydispersity, (90° scattering angle) | 0.30 | 0.19 |
| % C, H, N (microanalysis) before | | 3.7/0.80/0.52 |
| washing, 10B | | |
| Expected % N if all of amino silane is | | 0.51 |
| added | | |
| % C, H, N (microanalysis) after washing, | | 3.7/0.82/0.50 |
| 10C | | |
| % retention of C/H/N after washing | | 99/103/97 |

### Example 11

### Treatment of Colloidal Silica with 3-(N-allylamino)propyltrimethoxysilane and HMDS

This example demonstrates that colloidal SiO₂ can be surface modified by unsaturated secondary aliphatic aminosilanes without substantial agglomeration.

A 500 ml 3-necked jacketed flask, equipped with reflux condenser and mechanical paddle stirrer, was charged with Gelest SiO₂/IPA (63.5 g, 31.5 wt % SiO₂ in isopropyl alcohol) and isopropyl alcohol (250 g) and allowed to stir a couple minutes at ambient temperature. 3-(N-allylamino)propyltrimethoxysilane (1.4 g) diluted with isopropyl alcohol (16 g) was added to the flask via syringe injection with stirring at ambient temperature. The reaction mixture became hazy and remained fluid. The reaction was allowed to proceed at ambient temperature for 18 hr at which time it was heated to 50° C. for 1 hr then 80° C. for 1 hr before cooling to ambient temperature. The reaction mixture was hazy and fluid after cooling, with no gellation.

A 200 g aliquot of reaction mixture was withdrawn and evaporated to dryness under vacuum at 25° C. to yield 14.4 g of pale yellow granular solid. The solid was analyzed for organic ligand content by determining the percent weight loss after thermogravimetric ashing of the sample in air. It was determined the sample contained 4.7 wt % of the allylaminopropyl ligand after evaporation.

A 1.0 g sample of the granular solid was washed 4× in toluene. For each wash, the solids were suspended and agitated in 35-40 ml of solvent then centrifuged at 3300 rpm to separate the solids from the solvent. The supernatant was then decanted and the next wash was conducted. After the last wash, the solids were dried under reduced pressure at ambient temperature for 18 hr then at 100° C. for 18 hr. The washed solid was analyzed for organic ligand content by determining the percent weight loss after thermogravimetric ashing of the sample in air. It was determined the sample contained 4.7 wt % of the allylaminopropyl ligand after washing. This demonstrates that 100% of the allylaminopropyl ligand is attached to the surface of the colloidal SiO₂ particles and none of the organic ligand was unattached and removed by washing.

To the balance of reaction mixture was added 1,1,1,3,3,3-hexamethyldisilazane (4 g) at ambient temperature in a 500 ml 3-necked jacketed flask, equipped with reflux condenser and mechanical paddle stirrer. With gentle stirring, the reaction mixture was heated to 50° C. for 1 hr then 80° C. for 48 hr. After 48 hr, much of the haziness was gone and the reaction mixture was largely transparent. After cooling to ambient temperature, the cooled reaction mixture was fluid and nearly transparent, with no gellation.

A sample of the cooled reaction mixture was withdrawn, diluted to 0.25 wt % with isopropyl alcohol and subjected to ultrasonic agitation. Analysis of the diluted reaction mixture by dynamic light scattering in a Brookhaven Instruments BI9000 showed that the effective diameter (which is most sensitive to the largest particles in the colloidal dispersion) is equal to 29 nm (D₅₀=22.6 nm) which is nearly equal to that of the untreated colloidal silica (16-20 nm), indicating that agglomeration of the particles has not occurred to a significant extent.

What is claimed is:

1. A process comprising forming a reaction mixture comprising a dispersion of colloidal silica nanoparticles and an aminosilane of Formula 1: 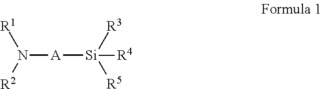
wherein
R¹ and R² are independently selected from the group consisting of H, C₁-C₁₀ alkyl, C₃-C₁₀ alkenyl, and C₆-C₁₀ aryl;
A is a linker group selected from the group consisting of C₁-C₂₀ alkylene, C₆-C₂₀ arylene, and C₇-C₂₀ arylalkylene;
R³ is a C₁-C₁₀ alkoxy group; and
R⁴ and R⁵ are independently selected from the group consisting of C₁-C₁₀ alkyl and C₁-C₁₀ alkoxy groups,
provided that if R¹ and R² are H, A is phenylene.

2. The process of claim 1, wherein R¹ and R² are H, and A is phenylene.

3. The process of claim 1, wherein R¹ is H and R² is n-butyl, allyl or phenyl.

4. The process of claim 1, wherein R³, R⁴, and R⁵ are independently selected from methoxy and ethoxy groups.

5. The process of claim 1, wherein A=—(CH₂CH₂CH₂)— and R¹ is phenyl, C₃-C₁₀ alkenyl, or C₁-C₁₀ alkyl.

6. The process of claim 1, wherein the dispersion comprises an organic solvent.

7. The process of claim 1, further comprising isolating aminosilane-modified silica nanoparticles from the dispersion.

8. The process of claim 7, further comprising washing the aminosilane-modified silica nanoparticles with a solvent selected from the group consisting of alcohols, aromatic solvents, ethers, and combinations thereof.

9. A composition comprising aminosilane-modified silica nanoparticles, wherein the aminosilane is an aminosilane of Formula 1: 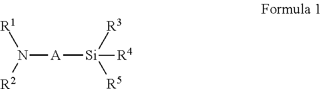
wherein
R¹ and R² are independently selected from the group consisting of H, C₁-C₁₀ alkyl, C₃-C₁₀ alkenyl, and C₆-C₁₀ aryl;
A is a linker group selected from the group consisting of C₁-C₂₀ alkylene, C₆-C₂₀ arylene, and C₇-C₂₀ arylalkylene;
R³ is a C₁-C₂₀ alkoxy group; and
R⁴ and R⁵ are independently selected from the group consisting of C₁-C₁₀ alkyl and C₁-C₁₀ alkoxy groups,
provided that if R¹ and R² are H, A is phenylene.

10. The composition of claim 9, wherein the average particle size of the aminosilane-modified silica nanoparticles is 5 75 nm.

11. The composition of claim 10, wherein the average particle size of the aminosilane-modified silica nanoparticles is 10-50 nm.

12. The composition of claim 9, wherein R¹ and R² are H, and A is phenylene.

13. The composition of claim 9, wherein R¹ is H and R² is n-butyl, allyl or phenyl.

14. The composition of claim 9, wherein R³, R⁴, and R⁵ are independently selected from methoxy and ethoxy groups.

15. The composition of claim 9, wherein A=—(CH₂CH₂CH₂)— and R¹ is C₁-C₁₀ alkyl, C₃-C₁₀ alkenyl, or phenyl.

16. A composition comprising aminosilane-modified silica nanoparticles produced by the process of claim 1.
